(19) United States
(12) Patent Application Publication
(10) Pub. No.: US 2022/0363880 A1
(43) Pub. Date: Nov. 17, 2022

(54) POLYMER COMPOSITION SUITABLE FOR MAKING BLOWN FILMS

(71) Applicant: BOREALIS AG, Vienna (AT)

(72) Inventors: Jingbo WANG, Linz (AT); Markus GAHLEITNER, Linz (AT); Klaus BERNREITNER, Linz (AT); Pauli LESKINEN, Porvoo (FI)

(21) Appl. No.: 17/765,907

(22) PCT Filed: Sep. 30, 2020
(86) PCT No.: PCT/EP2020/077284

§ 371 Date: Apr. 1, 2022

(30) Foreign Application Priority Data
Oct. 1, 2019 (EP) 19200680.7

(51) Int. Cl. C08L 23/14; C08J 5/18

(52) U.S. Cl. CPC C08L 23/142; C08J 5/18; C08L 2205/025; C08L 2207/066; C08L 2314/06; C08L 2203/162; C08J 2323/14; C08J 2423/06

(57) ABSTRACT

The present invention relates to a polymer composition comprising at least the following components: A) 70.0 to 95.0 wt.-% based on the overall weight of the polymer composition of a C₂C₃ random copolymer; whereby said C₂C₃ random copolymer has a melting point in the range of 110 to 140° C. determined by differential scanning calorimetry according to ISO 11357-3; a MFR₂ (230° C., 2.16 kg) determined according to ISO 1133 in the range of 0.5 to 4.0 g/10 min; and a total C2-content in the range of 1 to 10 wt.-% based on the overall weight of the C₂C₃ random copolymer; B) 5.0 to 30.0 wt.-% based on the overall weight of the polymer composition of a LDPE; whereby said LDPE has a density determined according to ISO 1183 in the range of 915 to 922 kg/m³; and a MFR2 (190° C., 2.16 kg) determined according to ISO 1133 in the range of 0.9 to 20.0 g/10 min; with the proviso that the weight proportions of components A) and B) add up to 100 wt.-%. In addition, the present invention refers to the articles, preferably blown films made of said polymer composition

The present invention relates to a polymer composition comprising as component A) a specific C₂C₃ random copolymer and as component B) a specific LDPE. In addition, the present invention relates to an article comprising said polymer composition and preferably said article is a blown film.

Polypropylenes succeed more and more to replace polyethylenes in many technical fields, as quite often the new generation of polypropylenes have enhanced properties compared to conventional polyethylene materials. This applies also for the field of blown films where polypropylene takes advantage of molecular engineering to overcome previous material shortcomings for blown-film production.

The blown films sector constitutes an area of ever-increasing importance in various application segments, such as industry packaging, consumer packaging, bags and sacks, lamination films, barrier films, packaging of food or medical products, agriculture films, hygienic products and products packaging.

It is desired to have a packaging material with satisfactory optical properties, such as low haze, having also good mechanical and sealing properties. It frequently turns out that improvement of one of the desired properties is achieved at the expense of at least one of the other properties. Several attempts have been made to solve the above problems.

WO 97/42258 A1 refers to polyolefin compositions for seal/peel films, comprising (percent by weight): A) from 20 to 50% of HDPE, LDPE or EVA having MFR higher than 0.3 g/10 min; B) from 30 to 80% of a random copolymer of propylene with ethylene and/or a C4-C8 alpha-olefin, or of a polyolefin composition comprising not less than 20% of said random copolymer of propylene; C) from 0 to 20% of an elastomeric or elastomeric thermoplastic olefin polymer. Optical properties of the respective films are not disclosed, but the composition implies poor haze levels.

EP 1 813 423 A1 relates to transparent and stiff coextruded polypropylene blown films with ink-printable skin layer(s) bonded to the base or core layer without intermediate layers, whereby the core layer or base layer comprises at least 50% of at least one of a polypropylene homopolymer, a polypropylene random copolymer or a heterophasic polypropylene copolymer and the skin layer(s) consists (consist) of either a mixture of at least 50% of low density polyethylene and at least 10% metallocene linear low density polyethylene and up to 5% of common additives or a polypropylene random copolymer with a MFR between 0.8 and 3.0 g/10 min (ISO1133 at 230° C., 2.16 kg) mixed with up to 50% of a low density polyethylene, linear low density polyethylene or metallocene linear low density polyethylene, MFR 0.5 to 3.5 g/10 min, and up to 5% common additives. The films are useful for label applications and for lamination, but have a poor thermal stability because of the high polyethylene content.

EP 1 831 016 A2 refers to film materials or structures obtained by co-extruding a rubber-impact modified heterophasic copolymer core layer with at least a second polyolefin. The second polyolefin may be a Ziegler-Natta catalyzed polyethylene (ZN PE), Ziegler-Natta catalyzed polypropylene random copolymer (ZN PP RCP), a metallocene catalyzed polypropylene random copolymer (mPP RCP), a linear low density polyethylene (LLDPE) and/or a metallocene catalyzed medium density polyethylene (mMDPE). These sheet or film materials may be co-extruded with other resins or laminated with other materials after extrusion. The heterophasic base polymer will necessarily cause high haze for the respective films.

Starting therefrom, it is one objective of the present to provide polymer compositions allowing manufacturing a blown film having improved optical properties, especially a low haze, and show at the same time also good mechanical and sealing properties. In addition, it is an object of the present invention to provide polymer composition having good processing properties, especially during the processing to blown films.

These objects have been solved by the polymer composition according to claim 1 comprising at least the following components:
A) 70.0 to 95.0 wt.-% based on the overall weight of the polymer composition of a C₂C₃ random copolymer; whereby said C₂C₃ random copolymer has
   a melting point in the range of 110 to 140° C. determined by differential scanning calorimetry according to ISO 11357-3;
   a MFR₂ (230° C., 2.16 kg) determined according to ISO 1133 in the range of 0.5 to 4.0 g/10 min; and
   a total C2-content in the range of 1 to 10 wt.-% based on the overall weight of the C₂C₃ random copolymer;
B) 5.0 to 30.0 wt.-% based on the overall weight of the polymer composition of a LDPE; whereby said LDPE has
   a density determined according to ISO 1183 in the range of 915 to 922 kg/m³; and
   a MFR₂ (190° C., 2.16 kg) determined according to ISO 1133 in the range of 0.9 to 20.0 g/10 min;
      with the proviso that the weight proportions of components A) and B) add up to 100 wt.-%.

Advantageous embodiments of the polymer composition in accordance with the present invention are specified in the dependent claims 2 to 8.

Claim 9 of the present invention relates to an article comprising the polymer composition according to the present invention and claim 10 specifies said article as a blown film. Claims 11 to 13 refer to advantageous embodiments of the blown film and claim 14 refers to flexible packaging systems comprising the blown film according to the present invention.

### DEFINITIONS

### Indications of Quantity

The polymer compositions in accordance with the present invention comprise the components A) and B) and optionally additives. The requirement applies here that the components A) and B) and if present the additives add up to 100 wt.-% in sum. The fixed ranges of the indications of quantity for the individual components A) and B) and optionally the additives are to be understood such that an arbitrary quantity for each of the individual components can be selected within the specified ranges provided that the strict provision is satisfied that the sum of all the components A), B) and optionally the additives add up to 100 wt.-%.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

C₂C₃ Random Copolymer (Component A))

The polymer composition in accordance with the present invention comprises as component A) 70.0 to 95.0 wt.-% based on the overall weight of the polymer composition of a C₂C₃ random copolymer; whereby said C₂C₃ random copolymer has a melting point in the range of 110 to 140° C. determined by differential scanning calorimetry according to ISO 11357-3; a MFR₂ (230° C., 2.16 kg) determined according to ISO 1133 in the range of 0.5 to 4.0 g/10 min; and a total C2-content in the range of 1 to 10 wt.-% based on the overall weight of the C₂C₃ random copolymer.

Preferred embodiments of component A) will be discussed in the following.

According to one preferred embodiment of the present invention component A) is consisting of a1) 50.0 to 85.0 wt.-% of a polymer fraction having i) a C2-content in the range of 2.0 to less than 5.5 wt.-%, preferably in the range of 2.0 to 5.49 wt.-%; and ii) a melt flow rate MFR₂ (230° C., 2.16 kg) determined according to ISO 1133 in the range of 0.5 to 5.0 g/10 min; and a2) 15.0 to 50.0 wt.-% of a polymer fraction having i) a C2-content in the range of 5.5 to 10.0 wt.-%; and ii) a melt flow rate MFR₂ (230° C./2.16 kg) measured according to ISO 1133 in the range of 0.1 to 3.0 g/10 min; whereby; the melt flow rate MFR₂ (230° C./2.16 kg) of polymer fraction a2) is lower than the MFR₂ (230° C./2.16 kg) of polymer fraction al).

In another preferred embodiment component A) has a melting point in the range of 115 to 138° C., preferably in the range of 120 to 136° C. and more preferably in the range of 128 to 135° C. determined by differential scanning calorimetry according to ISO 11357-3.

Another preferred embodiment of the present application stipulates that component A) has a total C2-content in the range of 1.5 to 8.0 wt.-%, preferably in the range of 2.0 to 7.0 wt.-% and more preferably in the range of 2.5 to 5.5 wt.-% based on the overall weight of component A).

According to still another preferred embodiment component A) has a melt flow rate MFR₂ (230° C./2.16 kg) measured according to ISO 1133 in the range of 0.7 to 3.5 g/10 min, preferably in the range of 0.8 to 2.5 g/10 min, more preferably in the range of 1.0 to 2.0 g/10 min and even more preferably in the range of 1.0 to 1.5 g/10 min.

Still another preferred embodiment of the present invention stipulates that component A) has a xylene soluble content (XCS) determined according to ISO 16152, 1 ed, 25° C., based on the overall weight of component A) in the range of 0.5 to 15.0 wt.-%, preferably in the range of 1.0 to 10.0 wt.-% and more preferably in the range of 2.5 to 4.5 wt.-%.

In a further preferred embodiment of the present invention component A) has a content of units originating from comonomers different from ethylene and propylene of below 7 wt.-%, preferably in the range of 0 to 3 wt.-% based on the overall weight of component A), more preferably in the range of 0.1 to 3 wt.-% and still more preferably component A) consists of units originating from ethylene and propylene.

According to another preferred embodiment of the present invention component A) has a glass transition temperature in the range of −20 to 0° C. and preferably in the range of −10 to −1° C. determined by differential scanning calorimetry according to ISO 11357-2.

In another preferred embodiment of the present invention the content of component A) in the polymer composition is in the range of 75 to 94 wt.-%, preferably in the range of 85 to 93 wt.-% and more preferably in the range of 88 to 92 wt.-% based on the overall weight of the polymer composition.

Still another preferred embodiment of the present invention stipulates that component A) is obtainable, preferably obtained, in the presence of a metallocene catalyst.

A preferred metallocene catalyst comprises

i) a complex of formula (I):

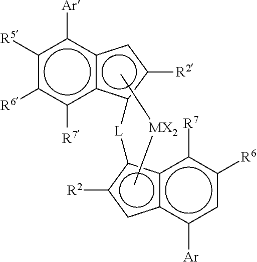

wherein M is zirconium or hafnium;

each X is a sigma ligand;

L is a divalent bridge selected from —R′₂C—, —R′₂C—CR′₂—, —R′₂Si—, —R′₂Si—SiR′₂—, —R′₂Ge—, wherein each R′ is independently a hydrogen atom, C₁-C₂₀-hydrocarbyl, tri(C₁-C₂₀-alkyl)silyl, C₆-C₂₀-aryl, C₆-C₂₀-arylalkyl or C₆-C₂₀-alkylaryl;

R² and R^{2′} are each independently a C₁-C₂₀-hydrocarbyl radical optionally containing one or more heteroatoms from groups 14 to 16;

R^{5′} is a C₁₋₂₀-hydrocarbyl group containing one or more heteroatoms from groups 14 to 16 optionally substituted by one or more halo atoms;

R⁶and R^{6′} are each independently hydrogen or a C₁₋₂₀-hydrocarbyl group optionally containing one or more heteroatoms from groups 14-16; wherein R^{6′} is preferably a tertiary alkyl group;

R⁷ is hydrogen or C₁₋₂₀-hydrocarbyl group optionally containing one or more heteroatoms from groups 14-16 and R⁷′ is hydrogen;

Ar and Ar′ each are independently an aryl or heteroaryl group having up to 20 carbon atoms optionally substituted by one or more groups R¹;

each R¹ is a C₁₋₂₀-hydrocarbyl group or two R¹ groups on adjacent carbon atoms taken together can form a fused 5 or 6 membered non aromatic ring with the Ar or Ar′ group, said ring being itself optionally substituted with one or more groups R⁴; each R⁴ is a C₁₋₂₀-hydrocarbyl group; and

(ii) a cocatalyst comprising at least one or two compounds of a group 13 metal, preferably a Al and/or boron compound.

Conditions for manufacturing component A) are described in an at the time of filing the present application unpublished European patent application (application number: 19177302.7, filed on May 29, 2019) of the same applicant as the present application.

Component A) is preferably prepared by polymerizing propylene and ethylene by a sequential polymerization process comprising at least two reactors connected in series in the presence of a metallocene catalyst.

Preferably component A) is prepared in a sequential polymerization process comprising at least two polymerization reactors (R1) and (R2), whereby in the first polymerization reactor (R1) a first polymer fraction a1) is produced, which is subsequently transferred into the second polymerization reactor (R2). In the second polymerization reactor (R2), a second polymer fraction a2) is then produced in the presence of the first polymer fraction al).

Polymerization processes which are suitable for producing component A) generally comprise at least two polymerization stages and each stage can be carried out in solution, slurry, fluidized bed, bulk or gas phase.

A preferred multistage process for manufacturing component B) is a “loop-gas phase”-process, such as developed by Borealis (known as BORSTAR® technology) which is described e.g. in patent literature, such as in EP 0 887 379 A1, WO 92/12182 A1, WO 2004/000899 A1, WO 2004/111095 A1, WO 99/24478 A1, WO 99/24479 A1 or in WO 00/68315 A1. A further suitable slurry-gas phase process is the Spheripol® process of Basell.

A preferred cocatalyst system for manufacturing component A) comprises a boron containing cocatalyst, like borate cocatalyst and an aluminoxane cocatalyst. Even more preferably, the catalyst is supported on a silica support.

Generally, the catalyst system used in the present invention may be prepared as described in WO 2018/122134 A1. The catalyst can be used in supported or unsupported form, preferably in supported form.

### Component B)

The polymer composition according to the present invention comprises as component B) 5.0 to 30.0 wt.-% based on the overall weight of the polymer composition of a LDPE; whereby said LDPE has a density determined according to ISO 1183 in the range of 915 to 922 kg/m³; and a MFR₂ (190° C., 2.16 kg) determined according to ISO 1133 in the range of 0.9 to 20.0 g/10 min.

Preferred embodiments of component B) will be discussed in the following.

According to one preferred embodiment of the present invention component B) has a MFR₂ (190° C., 2.16 kg) determined according to ISO 1133 in the range of 2.0 to 15.0 g/10 min, preferably in the range of 4.0 to 12.0 g/10 min, more preferably in the range of 6.5 to 10.0 g/10 min and still more preferably in the range from 6.5 to 8.0 g/10 min.

Another preferred embodiment in accordance with the present invention stipulates that component B) has a density determined according to ISO 1183 in the range of 916 to 922 kg/m³, preferably in the range of 917 to 921 kg/m³ and more preferably is 920 kg/m³ kg/m³.

In a further preferred embodiment of the present invention component B) has a content of hexane solubles determined on a 100 μm thick cast film according to FDA 177.1520 in the range of 0 to 10.0 wt.-%, preferably in the range of 0 to 5.0 wt.-% and more preferably in the range of 0 to 1.0 wt.-% based on the overall weight of component B).

Still another preferred embodiment of the present invention stipulates that component B) has a melting point determined by differential scanning calorimetry according to ISO 11357-3 in the range of 90 to 120° C., preferably in the range of 95 to 115° C., more preferably in the range of 100 to 115° C. and yet more preferably in the range of 107 to 110° C.

According to a further preferred embodiment of the present invention the content of component B) in the polymer composition is in the range of 6 to 25 wt.-%, preferably in the range of 7 to 15 wt.-% and more preferably in the range of 8 to 12 wt.-% based on the overall weight of the polymer composition.

Preferred materials for component B) are inter alia commercially available from Borealis AG (Austria) under the trade names CA8200 and CA9150.

### Additives

The polymer composition according to the present invention may also comprise additives.

According to a preferred embodiment of the present invention the polymer composition comprises at least one additive preferably selected from the group consisting of slip agents, acid scavengers, UV-stabilisers, pigments, antioxidants, additive carriers, nucleating agents and mixtures thereof, whereby these additives preferably are present in 0.1 to 5.0 wt.-% and more preferably in 0.1 to 4.0 wt.-% based on the overall weight of the polymer composition.

Examples of antioxidants which may be used, are sterically hindered phenols (such as CAS No. 6683-19-8, also sold as Irganox 1010 FF™ by BASF), phosphorous based antioxidants (such as CAS No. 31570-04-4, also sold as Hostanox PAR 24 (FF)™ by Clariant, or Irgafos 168 (FF)™ by BASF), sulphur based antioxidants (such as CAS No. 693-36-7, sold as Irganox PS-802 FL™ by BASF), nitrogen-based antioxidants (such as 4,4′-bis(1,1′-dimethylbenzyl)diphenylamine), or antioxidant blends.

UV-stabilisers which might be used in the polymer compositions according to the present invention are, for example, Bis-(2,2,6,6-tetramethyl-4-piperidyl)-sebacate (CAS-No. 52829-07-9, Tinuvin 770); 2-hydroxy-4-n-°Ctoxy-benzophenone (CAS-No. 1843-05-6, Chimassorb 81).

Nucleating agents that can be used in the polymer compositions according to the present invention are for example sodium benzoate (CAS No. 532-32-1) or 1,3:2,4-bis(3,4-dimethylbenzylidene)sorbitol (CAS 135861-56-2, Millad 3988).

### Polymer Composition

Below preferred embodiments of the polymer composition according to the present invention will be discussed.

Another preferred embodiment of the present invention stipulates that the content of component A) in the polymer composition is in the range of 75 to 94 wt.-%, preferably in the range of 85 to 93 wt.-% and more preferably in the range of 88 to 92 wt.-% based on the overall weight of the polymer composition and/or the content of component B) in the polymer composition is in the range of 6 to 25 wt.-%, preferably in the range of 7 to 15 wt.-% and more preferably in the range of 8 to 12 wt.-% based on the overall weight of the polymer composition.

A preferred polymer composition according to the present invention comprises and preferably consists of the following components:
A) 65.0 to 94.9 wt.-% and preferably 84.0 to 92.75 wt.-% based on the overall weight of the polymer composition of a C₂C₃ random copolymer; whereby said C₂C₃ random copolymer has
   a melting point in the range of 110 to 140° C. and preferably in the range of 128 to 135° C. determined by differential scanning calorimetry according to ISO 11357-3;
   a MFR₂ (230° C., 2.16 kg) determined according to ISO 1133 in the range of 0.5 to 4.0 g/10 min and preferably in the range of 1.0 to 2.0 g/10 min; and
   a total C2-content in the range of 1 to 10 wt.-% and preferably in the range of 2.5 to 5.5 wt.-% based on the overall weight of the C₂C₃ random copolymer;
B) 5.0 to 30.0 wt.-% and preferably 7 to 15 wt.-% based on the overall weight of the polymer composition of a LDPE; whereby said LDPE has

a density determined according to ISO 1183 in the range of 915 to 922 kg/m³ and preferably in the range of 917 to 921 kg/m³; and
a MFR₂ (190° C., 2.16 kg) determined according to ISO 1133 in the range of 0.9 to 20.0 g/10 min preferably in the range of 6.5 to 10.0 g/10 min;
C) 0.1 to 5.0 wt.-% and preferably 0.25 to 1.0 wt.-% based on the overall weight of the polymer composition of additives preferably selected from the group consisting of slip agents, acid scavengers, UV-stabilisers, pigments, antioxidants, additive carriers, nucleating agents and mixtures thereof;
   with the proviso that the weight proportions of components A), B) and C) add up to 100 wt.-%.

### Blown Film

The present invention also relates to blown films comprising or consisting of the polymer composition in accordance with the present invention.

Below preferred embodiments of the blown film according to the present invention will be discussed.

According to one preferred embodiment of the present invention the blown film has a sealing initiation temperature determined on a blown film having a thickness of 50 μm in the range of 80° C. to below 120° C., preferably in the range of 90° C. to 110° C. and more preferably in the range of 98° C. to 105° C.

In a further preferred embodiment the crystallization temperature (T_{c}) determined on a blown film having a thickness of 50 μm measured by differential scanning calorimetry according to ISO 11357-3 is in the range of 80 to 95° C. and preferably in the range of 85 to 90° C.

Still another preferred embodiment of the present invention stipulates that the blown film has two melting points wherein the first melting point determined by differential scanning calorimetry according to ISO 11357-3 is in the range of 110 to 130° C., preferably in the range of 115 to 125° C. and more preferably in the range of 119 to 121° C. and the second melting point determined by differential scanning calorimetry according to ISO 11357-3 is in the range from 100 to 115° C., preferably in the range of 103 to 112° C. and more preferably in the range of 106 to 108° C.

According to another preferred embodiment of the present invention the blown film has a tensile modulus determined according to ISO 527-3 at 23° C. on a blown film with a thickness of 50 μm in machine direction as well as in transverse direction in the range of 200 to 1000 MPa, preferably in the range of 300 to 700 MPa and more preferably in the range of 500 to 600 MPa.

In a further preferred embodiment of the present invention the blown film has a dart-drop impact strength determined according to ASTM D1709, method A on a blown film with a thickness of 50 μm in the range of 20 to 2000 g, preferably in the range of 40 to 1000 g, more preferably in the range of 45 to 500 g, still more preferably in the range of 50 to 300 g and even more preferably in the range of 55 to 80 g.

Still another preferred embodiment of the present invention stipulates that the blown film has an Elmendorf tear strength determined in accordance with ISO 6383/2 measured in machine direction in the range of 1.0 N/mm to 50.0 N/mm, preferably in the range of 4.0 to 20.0 N/mm and more preferably in the range of 6.0 to 10.0 N/mm.

According to a further preferred embodiment in accordance with the present invention the blown film has an Elmendorf tear strength determined in accordance with ISO 6383/2 measured in transverse direction (TD) in the range of 5.0 N/mm to 100.0 N/mm, preferably in the range of 10.0 to 40.0 N/mm and more preferably in the range of 15.0 to 25.0 N/mm.

A further preferred embodiment of the present invention stipulates that the blown film has a haze determined according to ASTM D1003-00 on a blown film with a thickness of 50 μm below 4.2%, preferably in the range of 0.1 to 4.0% and more preferably in the range of 0.5 to 3.3%.

For manufacturing the blown film a melt of the polymer composition according to the present invention is extruded through an annular die and blown into a tubular film by forming a bubble which is collapsed between nip rollers after solidification. The blown extrusion can be preferably 25 effected at a temperature in the range 160 to 240° C., and cooled by water or preferably by blowing gas (generally air) at a temperature of 10 to 50° C. to provide a frost line height of 0.5 to 8 times the diameter of the die. The blow up ratio should generally be in the range of from 1.5 to 4, such as from 2 to 4, preferably 2.5 to 3.5.

### Flexible Packaging Systems

The present invention also relates to flexible packaging systems, selected from bags or pouches for food and pharmaceutical packaging comprising a blown film in accordance with the present invention.

The invention will now be described with reference to the following non-limiting examples.

### EXPERIMENTAL PART

### A. Measuring Methods

The following definitions of terms and determination methods apply for the above general description of the invention as well as to the below examples unless otherwise defined.

### Melt Flow Rate

The melt flow rate (MFR) was determined according to ISO 1133—Determination of the melt mass-flow rate (M FR) and melt volume-flow rate (MVR) of thermoplastics—Part 1: Standard method and is indicated in g/10 min. The MFR is an indication of the flowability, and hence the processability, of the polymer. The higher the melt flow rate, the lower the viscosity of the polymer. The MFR₂ of polyethylene is determined at a temperature of 190° C. and a load of 2.16 kg. The MFR₂ of polypropylene is determined at a temperature of 230° C. and a load of 2.16 kg.

### Determination of the C2- and C3-Content in Component A) by NMR

Quantitative nuclear-magnetic resonance (NMR) spectroscopy was further used to quantify the comonomer content and comonomer sequence distribution of the polymers. Quantitative ¹³C{H} NMR spectra were recorded in the solution-state using a Bruker Advance III 400 NMR spectrometer operating at 400.15 and 100.62 MHz for¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatary oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6 k) transients were acquired per spectra. Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

With characteristic signals corresponding to 2,1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required. Characteristic signals corresponding to other types of regio defects were not observed.

The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

E=0.5(Sββ+Sβγ+Sβδ+0.5(Sαβ+Sαγ))

Through the use of this set of sites the corresponding integral equation becomes:

E=0.5(I_{H}+I_{G}+0.5(I_{C}+I_{D}))

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

E[mol-%]=100*f

The weight percent comonomer incorporation was calculated from the mole fraction:

E[wt.-%]=100*(fE*28.06)/((fE*28.06)+((1−fE)*42.08))

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

### Xylene Cold Solubles (XCS)

The xylene soluble (XS) fraction as defined and described in the present invention is determined in line with ISO 16152 as follows: 2.0 g of the polymer were dissolved in 250 ml p-xylene at 135° C. under agitation. After 30 minutes, the solution was allowed to cool for 15 minutes at ambient temperature and then allowed to settle for 30 minutes at 25+/−0.5° C. The solution was filtered with filter paper into two 100 ml flasks. The solution from the first 100 ml vessel was evaporated in nitrogen flow and the residue dried under vacuum at 90° C. until constant weight is reached. The xylene soluble fraction (percent) can then be determined as follows:

XS %=(100*m*V₀)/(m₀*v); m₀=initial polymer amount (g); m=weight of residue (g); V₀=initial volume (ml); v=volume of analysed sample (ml).

Melting Temperature Tₘ, Crystallization Temperature T_{c} and Melting Enthalpy Hₘ

The melting temperature was determined with a TA Instrument Q2000 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. Crystallization temperature (T_{c}) is determined from the cooling step, while melting temperature (Tₘ) and melting enthalpy (Hₘ) are determined from the second heating step. For calculating the melting enthalpy 50° C. is used as lower integration limit. Melting and crystallization temperatures were taken as the peaks of endotherms and exotherms.

### Glass Transition Temperature T_{g}

The glass transition temperature Tg was measured by DSC according to ISO 11357/part 2.

### Density

Density of the materials was measured according to ISO 1183-1.

All film properties (except hexane solubles) were determined on monolayer blown films of 50 μm thickness produced on a Collin blown film line. This line has a screw diameter of 30 millimeters (mm), L/D of 30, a die diameter of 60 mm, a die gap of 1.5 mm and a duo-lip cooling ring. The film samples were produced at 210° C. with an average thickness of 50 μm, with a 2.5 blow-up ratio and an output rate of about 8 kilograms per hour (kg/h).

### Content of Hexane Solubles in Component A)

1 g of a polymer cast film of 100 μm thickness (chill roll temperature during film production=40° C.) was added to 400 ml hexane at 50° C. for 2 hours while stirring with a reflux cooler. After 2 hours the mixture is immediately filtered on a filter paper No 41. The precipitate is collected in an aluminium recipient and the residual hexane is evaporated on a steam bath under N2 flow. The amount of hexane solubles is determined by the formula

((wt. sample+wt. crucible)−(wt crucible))/(wt. sample)·100.

### Sealing Initiation Temperature (SIT); (Sealing end Temperature (SET), Sealing Range)

The sealing temperature range is the temperature range, in which the films can be sealed according to conditions given below. The lower limit (heat sealing initiation temperature (SIT)) is the sealing temperature at which a sealing strength of >5 N is achieved. The upper limit (sealing end temperature (SET)) is reached, when the films stick to the sealing device.

The sealing range was determined on a J&B Universal Sealing Machine Type 3000 with a film of 50 μm thickness with the following further parameters:

Specimen width: 25.4 mm

Seal Pressure: 0.1 N/mm²

Seal Time: 0.1 s

Cool time: 99 s

Peel Speed: 10 mm/s

Start temperature: 80° C.

End temperature: 150° C.

Increments: 10° C.

The specimen is sealed inside to inside at each sealbar temperature and seal strength (force) is determined at each step. The temperature is determined at which the seal strength reaches 5 N.

### Tensile Modulus

Tensile Modulus in machine and transverse direction are determined according to ISO 527-3 at 23° C. on blown films of 50 μm thickness produced on a monolayer cast film line with a melt temperature of 220° C. and a chill roll temperature of 20° C. with a thickness of 50 μm produced as indicated below. Testing was performed at a cross head speed of 1 mm/min.

### Dart-Drop Impact Strength (DDI)

DDI was measured using ASTM D1709, method A (Alternative Testing Technique) from the film samples. A dart with a 38 mm diameter hemispherical head was dropped from a height of 0.66 m onto a film clamped over a hole. Successive sets of twenty specimens are tested. One weight was used for each set and the weight is increased (or decreased) from set to set by uniform increments. The weight resulting in failure of 50% of the specimens is calculated and reported.

### Tear Strength

Tear Strength (determined as Elmendorf tear (N)): Applies both for the measurement in machine direction (MD) and transverse direction (TD). The tear strength was measured using the ISO 6383/2 method. The force required to propagate tearing across a film sample was measured using a pendulum device. The pendulum swings under gravity through an arc, tearing the specimen from pre-cut slit. The film sample was fixed on one side by the pendulum and on the other side by a stationary clamp. The tear resistance is the force required to tear the specimen. The relative tear resistance (N/mm) was then calculated by dividing the tear resistance by the thickness of the film.

### Haze

The haze was determined according to ASTM D1003-00 on films blown as described below with a thickness of 50 μm.

### B. Materials Used

C₂C₃ Random Copolymer (Component A))

In the Working Example according to the invention IE1 and in the Comparative Examples CE1 and CE2 a C₂C₃ random copolymer A) manufactured as follows was used.

The catalyst used in the polymerization processes for the C₂C₃ random copolymer A) was prepared as follows:

The metallocene (MC1) (rac-anti-dimethylsilandiyl(2-methyl-4-phenyl-5-methoxy-6-tert-butyl-indenyl)(2-methyl-4-(4-tert-butylphenyl)indenyl)zirconium dichloride)

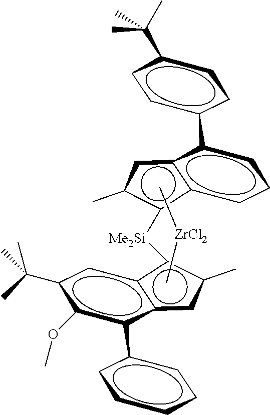

has been synthesized according to the procedure as described in WO 2013/007650 A1, E2.

### Preparation of MAO-Silica Support

A steel reactor equipped with a mechanical stirrer and a filter net was flushed with nitrogen and the reactor temperature was set to 20° C. Next silica grade DM-L-303 from AGC Si-Tech Co, pre-calcined at 600° C. (7.4 kg) was added from a feeding drum followed by careful pressuring and depressurising with nitrogen using manual valves. Then toluene (32 kg) was added. The mixture was stirred for 15 min. Next 30 wt.-% solution of MAO in toluene (17.5 kg) from Lanxess was added via feed line on the top of the reactor within 70 min. The reaction mixture was then heated up to 90° C. and stirred at 90° C. for additional two hours. The slurry was allowed to settle and the mother liquor was filtered off. The MAO treated support was washed twice with toluene (32 kg) at 90° C., following by settling and filtration. The reactor was cooled off to 60° C. and the solid was washed with heptane (32.2 kg). Finally MAO treated SiO2 was dried at 60° under nitrogen flow for 2 hours and then for 5 hours under vacuum (−0.5 barg) with stirring. MAO treated support was collected as a free-flowing white powder found to contain 12.6% Al by weight.

### Catalyst System Preparation

30 wt.-% MAO in toluene (2.2 kg) was added into a steel nitrogen blanked reactor via a burette at 20° C. Toluene (7 kg) was then added under stirring. Metallocene MC1 (286 g) was added from a metal cylinder followed by flushing with 1 kg toluene. The mixture was stirred for 60 minutes at 20° C. Trityl tetrakis(pentafluorophenyl) borate (336 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under N₂ flow at 60° C. for 2 h and additionally for 5 h under vacuum (−0.5 barg) under stirring. Dried catalyst was sampled in the form of pink free flowing powder containing 13.9 wt.-% Al and 0.26 wt.-% Zr.

The polymerization for preparing the C₂C₃ random copolymer (A) was performed in a Borstar pilot plant with a 2-reactor set-up (loop—gas phase reactor (GPR 1)). In Table 1 the polymerization conditions for the C₂C₃ random copolymer (A) are given.

TABLE 1
Preparation of the C₂C₃ random copolymer (A).
a

| Prepoly reactor | |
|---|---|
| Temperature [° C.] | 25 |
| Pressure [Pa] | 5190 |
| Catalyst feed [kg/h] | 1.8 |
| H2 [g/h] | 0.3 |
| Feed H2/C3 ratio [mol/kmol] | 0.09 |
| Residence time [h] | 0.4 |
| loop reactor | |
| Temperature [° C.] | 68 |
| Pressure [Pa] | 5387 |
| Feed H2/C3 ratio [mol/kmol] | 0.30 |
| Feed C2/C3 ratio [mol/kmol] | 48.26 |
| Polymer Split [wt.-%] | 65 |
| MFR₂ [g/10 min] (MFR of a1)) | 1.4 |
| Total C2 loop [wt.-%] (C2 of a1)) | 5.0 |
| Residence time | 0.43 |

b

| | |
|---|---|
| GPR1 | |
| Temperature [° C.] | 75 |
| Pressure [Pa] | 2500 |
| H2/C3 ratio [mol/kmol] | 3.0 |
| C2/C3 ratio [mol/kmol] | 217 |
| Polymer residence time (h) | 2.1 |
| Polymer Split [wt.-%] | 35 |
| Total MFR₂ [g/10 min] | 1.2 |
| MFR₂ [g/10 min] in GPR1 (MFR of a2)) | 1.1 |
| Total C2 [wt.-%] (loop + GPR1) | 4.9 |
| C2 in GPR1 [wt.-%] (C2 of a2)) | 4.7 |
| XCS [wt.-%] | 3.4 |
| Total productivity (kg PP/g cat) | 29 |

The polymer powder was compounded in a co-rotating twin-screw extruder Coperion ZSK 57 at 220° C. with 0.1 wt.-% antioxidant (Irgafos 168FF, CAS No. 6683-19-4), 0.1 wt.-% of a sterically hindered phenol (Irganox 1010FF, CAS No. 6683-19-8) and 0.05 wt.-% of Ca-stearate (wt.-% refer to the overall weight of the polymer powder).

TABLE 2
Properties of the C₂C₃ random copolymer copolymer (A).

| | | C₂C₃ |
|---|---|---|
| | | random |
| Physical property | unit | copolymer |
| MFR (230° C., 2.16 kg) | [g/10 min] | 1.2 |
| XCS total | [wt.-%] | 3.4 |
| C2-content | [wt.-%] | 4.9 |
| C3-content | [wt.-%] | 95.1 |
| Melting point, Tₘ | [° C.] | 118 |
| Crystallization | [° C.] | 80 |
| temperature, T_{c} | | |

### Component B)

CA8200: CA8200 is a low density polyethylene (LDPE) produced in a high pressure autoclave process having a Melt Flow Rate (190° C./2.16 kg) of 7.5 g/10 min, a melting temperature (determined by DSC according to ISO 11357/03) of 108° C., a density of 920 kg/m³ (determined according to ISO1183) and is commercially available from Borealis AG, Austria.

### Further Components

FT5230: FT5320 is a low density polyethylene commercially available from Borealis AG, Austria. It has a density of 923 kg/m³ (determined according to ISO1183), a Melt Flow Rate (190° C./2.16 kg) of 0.75 g/10 min and a melting temperature (determined by DSC according to ISO 11357/03) of 112° C.

### C. Manufacturing of Blown Films

Blending of the components was done in a Collin 30 lab scale blown film machine and a 50 μm monolayer blown film is produced with the same line (BUR=1:2.5). Before blending, the components were pre-mixed in an intensive mixer. In Table 3 the compositions of the polymer compositions according to Comparative Examples CE1 and CE2 and the Inventive Examples IE1 and film parameters are shown.

TABLE 3
Composition and properties of blown films.

| | Unit | CE1 | CE2 | IE1 |
|---|---|---|---|---|
| Component | | | | |
| C₂C₃ random copolymer (A) | wt.-% | 100 | 90 | 90 |
| CA8200 (B) | wt.-% | — | — | 10 |
| FT5230 | wt.-% | — | 10 | — |
| Properties of a blown film | | | | |
| (50 μm thickness) | | | | |
| Dart Drop Impact | g | 56 | 64 | 65 |
| Haze | % | 4.2 | 12.3 | 3.1 |
| Tear Strength (MD) | N/mm | 8.07 | 7.94 | 8.22 |
| Tear Strength (TD) | N/mm | 19.76 | 19.69 | 22.77 |
| Sealing initiation temperature | ° C. | 104 | 101 | 103 |
| Crystallization temperature | ° C. | 82 | 88 | 87 |
| Melting temperature 1 | ° C. | 118 | 120 | 119 |
| Melting temperature 2 | ° C. | — | 111 | 107 |
| Melting enthalpy 1 | J/g | 62 | 11 | 12 |
| Melting enthalpy 2 | J/g | — | 56 | 57 |

### D. Discussion of the Results

As can be gathered from Table 3 the addition of the specific LDPE according to the present invention (component (B)) to component (A) allows to improve the optical properties, especially the haze, of a blown film (see comparison of CE1 and IE1) without deteriorating the mechanical properties of the blown film. CE2 demonstrates that the addition of a LDPE outside the scope of the present invention (FT5230) results in a film with poor optical properties, especially a significantly increased haze.

1. A polymer composition comprising at least the following components:
A) 70.0 to 95.0 wt.-% based on the overall weight of the polymer composition of a C₂C₃ random copolymer; whereby said C₂C₃ random copolymer has
a melting point in the range of 110 to 140° C. determined by differential scanning calorimetry according to ISO 11357-3;
a MFR₂ (230° C., 2.16 kg) determined according to ISO 1133 in the range of 0.5 to 4.0 g/10 min; and
a total C2-content in the range of 1 to 10 wt.-% based on the overall weight of the C₂C₃ random copolymer;
B) 5.0 to 30.0 wt.-% based on the overall weight of the polymer composition of a LDPE; whereby said LDPE has
a density determined according to ISO 1183 in the range of 915 to 922 kg/m³; and
a MFR₂ (190° C., 2.16 kg) determined according to ISO 1133 in the range of 0.9 to 20.0 g/10 min;
with the proviso that the weight proportions of components A) and B) add up to 100 wt.-%.

2. The polymer composition according to claim 1, characterized in that component A) is consisting of
a1) 50.0 to 85.0 wt.-% of a polymer fraction having
i) a C2-content in the range of 2.0 to less than 5.5 wt.-%, preferably in the range of 2.0 to 5.49 wt.-%; and
ii) a melt flow rate MFR₂ (230° C., 2.16 kg) determined according to ISO 1133 in the range of 0.5 to 5.0 g/10 min; and
a2) 15.0 to 50.0 wt.-% of a polymer fraction having
i) a C2-content in the range of 5.5 to 10.0 wt.-%; and
ii) a melt flow rate MFR₂ (230° C./2.16 kg) measured according to ISO 1133 in the range of from 0.1 to 3.0 g/10 min;
whereby the melt flow rate MFR₂ (230° C./2.16 kg) of polymer fraction a2) is lower than the MFR₂ (230° C./2.16 kg) of polymer fraction a1).

3. The polymer composition according to claim 1, characterized in that component A) has
a xylene soluble content (XCS) determined according to ISO 16152, led, 25° C., based on the overall weight of component A) in the range of 0.5 to 15.0 wt.-%,
a content of units originating from comonomers different from ethylene and propylene of below 7 wt.-%, based on the overall weight of component A),
a glass transition temperature in the range of −20 to 0° C. determined by differential scanning calorimetry according to ISO 11357-2;
or a combination thereof.

4. The polymer composition according to claim 1, characterized in that component A) is obtainable in the presence of a metallocene catalyst.

5. The polymer composition according to claim 1, characterized in that component B) has
a MFR₂ (190° C., 2.16 kg) determined according to ISO 1133 in the range of 2.0 to 15.0 g/10 min;
a density determined according to ISO 1183 in the range of 916 to 922 kg/m³;
a content of hexane solubles determined on a 100 μm thick cast film according to FDA 177.1520 in the range of 0 to 10.0 wt.-% based on the overall weight of component B);
a melting point determined by differential scanning calorimetry according to ISO 11357-3 in the range of 90 to 120° C.;
or a combination thereof.

6. The polymer composition according to claim 1, characterized in that the polymer composition comprises at least one additive C) present in an amount of 0.1 to 5.0 wt.-% based on the overall weight of the polymer composition.

7. The polymer composition according to claim 1, characterized in that:
the content of component A) in the polymer composition is in the range of 75 to 94 wt.-%, based on the overall weight of the polymer composition; and/or
the content of component B) in the polymer composition is in the range of 6 to 25 wt.-%, based on the overall weight of the polymer composition.

8. The polymer composition according to claim 1, characterized in that the polymer composition comprises:
A) 65.0 to 94.9 wt.-% based on the overall weight of the polymer composition of a C₂C₃ random copolymer; whereby said C₂C₃ random copolymer has
a melting point in the range of 110 to 140° C. determined by differential scanning calorimetry according to ISO 11357-3;
a MFR₂ (230° C., 2.16 kg) determined according to ISO 1133 in the range of 0.5 to 4.0 g/10 min; and
a total C2-content in the range of 1 to 10 wt. % based on the overall weight of the C₂C₃ random copolymer;
B) 5.0 to 30.0 wt.-% based on the overall weight of the polymer composition of a LDPE; whereby said LDPE has
a density determined according to ISO 1183 in the range of 915 to 922 kg/m³; and
a MFR₂ (190° C., 2.16 kg) determined according to ISO 1133 in the range of 0.9 to 20.0 g/10 min;
C) 0.1 to 5.0 wt.-% based on the overall weight of the polymer composition of additives selected from the group consisting of slip agents, acid scavengers, UV-stabilisers, pigments, antioxidants, additive carriers, nucleating agents and mixtures thereof;
with the proviso that the weight proportions of components A), B) and C) add up to 100 wt.-%.

9. An article comprising the polymer composition according to claim 1.

10. The article according to claim 9, wherein the article is a blown film.

11. The blown film according to claim 10, characterized in that,
the sealing initiation temperature of a blown film having a thickness of 50 μm is in the range of 80° C. to below 120° C.;
the crystallization temperature (T_{c}) of a blown film having a thickness of 50 μm determined by differential scanning calorimetry according to ISO 11357-3 is in the range of 80 to 95° C.;
the blown film has two melting points wherein the first melting point determined by differential scanning calorimetry according to ISO 11357-3 is in the range of 110 to 130° C., and the second melting point determined by differential scanning calorimetry according to ISO 11357-3 is in the range from 100 to 115° C.;
or a combination thereof.

12. The blown film according to claim 10, characterized in that:
the blown film has a tensile modulus determined according to ISO 527-3 at 23° C. on a blown film with a thickness of 50 μm in machine direction as well as in transverse direction in the range of 200 to 1000 MPa;
the blown film has a dart-drop impact strength determined according to ASTM D1709, method A on a blown film with a thickness of 50 μm in the range of 20 to 2000 g;
the blown film has an Elmendorf tear strength determined in accordance with ISO 6383/2 measured in machine direction in the range of 1.0 N/mm to 50.0 N/mm;
the blown film has an Elmendorf tear strength determined in accordance with ISO 6383/2 measured in transverse direction (TD) in the range of 5.0 N/mm to 100.0 N/mm;
or a combination thereof.

13. The blown film according to claim 10, characterized in that the blown film has a haze determined according to ASTM D1003-00 on a blown film with a thickness of 50 μm below 4.2%.

14. A flexible packaging system comprising a blown film according to claim 10, wherein the flexible packaging system comprises bags or pouches for food and/or pharmaceutical packaging.

15. The polymer composition according to claim 1, characterized in that, component A) has
a melting point in the range of 115 to 138° C., determined by differential scanning calorimetry according to ISO 11357-3;
a total C2-content in the range of 1.5 to 8.0 wt.-%, based on the overall weight of component A); and/or
a melt flow rate MFR₂ (230° C./2.16 kg) measured according to ISO 1133 in the range of 0.7 to 3.5 g/10 min;
or a combination thereof.

16. The polymer composition according to claim 4, wherein said metallocene catalyst comprises:
i) a complex of formula (I): 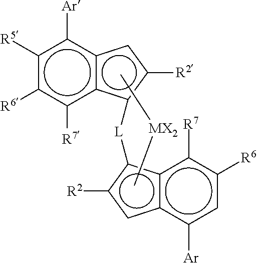
wherein
M is zirconium or hafnium;
each X is a sigma ligand;
L is a divalent bridge selected from —R′₂C—, —R′₂C—CR′₂—, —R′₂Si—, —R′₂Si—SiR′₂—, —R′₂Ge—, wherein each R′ is independently a hydrogen atom, C₁-C₂₀-hydrocarbyl, tri(C₁-C₂₀-alkyl)silyl, C₆-C₂₀-aryl, C₇-C₂₀-arylalkyl or C₇-C₂₀-alkylaryl;
R² and R^{2′} are each independently a C₁-C₂₀-hydrocarbyl radical optionally containing one or more heteroatoms from groups 14 to 16;
R^{5′} is a C₁₋₂₀-hydrocarbyl group containing one or more heteroatoms from groups 14 to 16 optionally substituted by one or more halo atoms;
R⁶ and R^{6′} are each independently hydrogen or a C₁₋₂₀-hydrocarbyl group optionally containing one or more heteroatoms from groups 14-16;
R⁷ is hydrogen or C₁₋₂₀-hydrocarbyl group optionally containing one or more heteroatoms from groups 14-16;
R^{7′} is hydrogen;
Ar and Ar′ each are independently an aryl or heteroaryl group having up to 20 carbon atoms optionally substituted by one or more groups R¹;
each R¹ is a C₁₋₂₀-hydrocarbyl group or two R¹ groups on adjacent carbon atoms taken together can form a fused 5 or 6 membered non aromatic ring with the Ar or Ar′ group, said ring being itself optionally substituted with one or more groups R⁴; each R⁴ is a C₁₋₂₀-hydrocarbyl group; and
(ii) a cocatalyst comprising at least one or two compounds of a group 13 metal.

17. The polymer composition according to claim 6, wherein additive C) is selected from the group consisting of slip agents, acid scavengers, UV-stabilisers, pigments, antioxidants, additive carriers, nucleating agents and mixtures thereof.

18. The polymer composition according to claim 8, characterized in that the polymer composition comprises:
A) 84.0 to 92.75 wt.-% based on the overall weight of the polymer composition of the C₂C₃ random copolymer;
B) 7 to 15 wt.-% based on the overall weight of the polymer composition of the LDPE;
C) preferably 0.25 to 1.0 wt.-% based on the overall weight of the polymer composition of additives;
with the proviso that the weight proportions of components A), B) and C) add up to 100 wt.-%.

19. The polymer composition according to claim 8, characterized in that:
said C₂C₃ random copolymer has a melting point in the range of 128 to 135° C. determined by differential scanning calorimetry according to ISO 11357-3;
a MFR₂ (230° C., 2.16 kg) determined according to ISO 1133 in the range of 1.0 to 2.0 g/10 min; and
a total C2-content in the range of 2.5 to 5.5 wt.-% based on the overall weight of the C₂C₃ random copolymer; and/or said LDPE has
a density determined according to ISO 1183 in the range of 917 to 921 kg/m³;
and
a MFR₂ (190° C., 2.16 kg) determined according to ISO 1133 in the range of 0

6. 5 to 10.0 g/10 min.
